(19) United States
(12) Patent Application Publication
(10) Pub. No.: US 2002/0080988 A1
(43) Pub. Date: Jun. 27, 2002

(54) Earpiece for auditory testing

(76) Inventor: Gabriel Raviv, Glenview, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/748,800

(22) Filed: Dec. 22, 2000

(51) Int. Cl. H04R 25/00

(52) U.S. Cl. 381/371; 381/370; 381/372

(57) ABSTRACT

An earpiece for auditory testing. In one form of the invention, an earpiece for auditory testing is provided which comprises a first baffle having a first side, a second side and a cover attached to the baffle first side and forming a first chamber. Further, an aperture may be located at one end of the first baffle so that the aperture communicates with the first chamber. Also provided may be a second baffle having a first portion, a second portion and an aperture located at one end of the second baffle and wherein the second baffle is located within the first chamber so that the second baffle aperture is positioned proximate the first baffle aperture and so that at least part of the second baffle first portion is attached to the cover and forms a second chamber. A transducer may be attached to at least a part of the first baffle second side and a conductive adhesive coating may cover at least a part of the first baffle first side and at least a part of the transducer.

### FIELD OF THE INVENTION

The present invention relates to earpieces for auditory testing, and more particularly to earpieces that provide for an enhanced sound delivery chamber.

### BACKGROUND OF INVENTION

Earpieces for auditory testing of various types are known in the art. Such devices are typically used in clinics or hospitals to conduct hearing screening tests on individuals. While adults may undergo hearing tests, it is especially critical to determine, at an early age, whether or not any hearing impairments exist. Detection of a child's hearing problem can be particularly advantageous because the problems and costs associated with the identified problem will be minimized.

During the evolution of screening for hearing-related deficiencies, several devices have been developed to introduce sound into a patient's ear and to detect a patient's response to that sound. The response may occur as a result of the characteristics of the introduced sound and the conditions inside the ear, the vibration transmission mechanism of the ear and the neural connections of the ear. After detection of the patient's response, the response is then analyzed to determine the patient's hearing capabilities and limitations.

Several earpiece devices in the prior art operate by using an earpiece having a single cavity. A response is generated by the patient's ear and is detected by a transducer of the earpiece. The transducer then generates a signal and delivers it to a processor and the characteristics and results are displayed on a viewing apparatus for analysis of the patient's hearing.

Earpieces for hearing testing, not in accordance with this invention, have some inherent disadvantages. First, prior art earpieces do not effectively block internal or external (to the cavity) ambient noises which interfere with the introduced sound and may interfere with the patient's response to the sound. These interferences provide flawed results and make accurate analysis impossible. One of the reasons that ambient noises cause interference is because the sound introduced through the earpiece is not directed straight into the ear canal. Instead, the sound is introduced into a chamber that surrounds the entire ear which causes the sound to reflect off the ear and the chamber walls before it enters the ear canal. Yet another disadvantage with the prior art is that existing earpieces for auditory testing do not provide effective hearing screening for infants because they are too difficult to use. Another disadvantage is that they are expensive to manufacture. Minimization of manufacturing cost is important because, according to accepted general medical practices, the earpieces must be disposed of as medical waste after use.

The present invention provides an earpiece for auditory testing that minimizes the amount of internal and external ambient noise that interferes with the hearing testing procedures and results. The present invention is lightweight and easy to use and as a result is easily used on both adults and infants. The present invention directs the sound input directly into the patients' ear canal thereby minimizing the interferences caused by external and internal ambient noise.

### SUMMARY OF THE INVENTION

In one embodiment of the invention, an earpiece for auditory testing is provided which comprises a first baffle having a first side, a second side and a substantially transparent cover attached to the baffle first side for forming a first chamber. The earpieces further comprises a second baffle positioned within the first cavity where a portion of the second baffle is attached to the cover to form a second cavity. The second baffle is also adapted to be coupled to a sound source to permit sound to be directed into the second cavity. In some embodiments of the earpiece, the cover may be planar, and in other embodiments, the cover may be non-planar. Further, some embodiments of the earpiece may include a conductive element or a conductive adhesive coating that is coupled to a portion of the first baffle. Additionally, the earpiece may include a tube for connecting the sound source to the second cavity, an aperature for coupling the sound source to the second cavity, or a transducer to deliver sound to the second cavity.

### BRIEF DESCRIPTION OF THE DRAWINGS

FIG. 1 is a front view of one embodiment of the earpiece for auditory testing of the present invention; and

FIG. 2 is a cross sectional view of the embodiment of FIG. 1.

### DETAILED DESCRIPTION

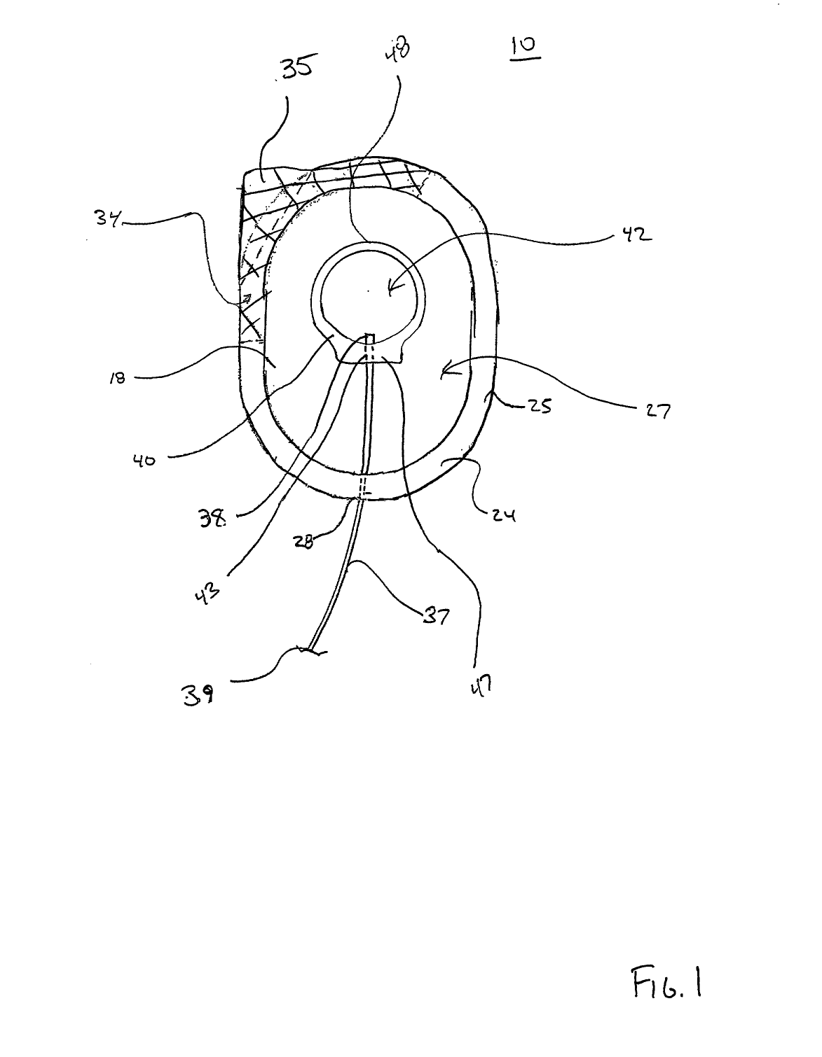

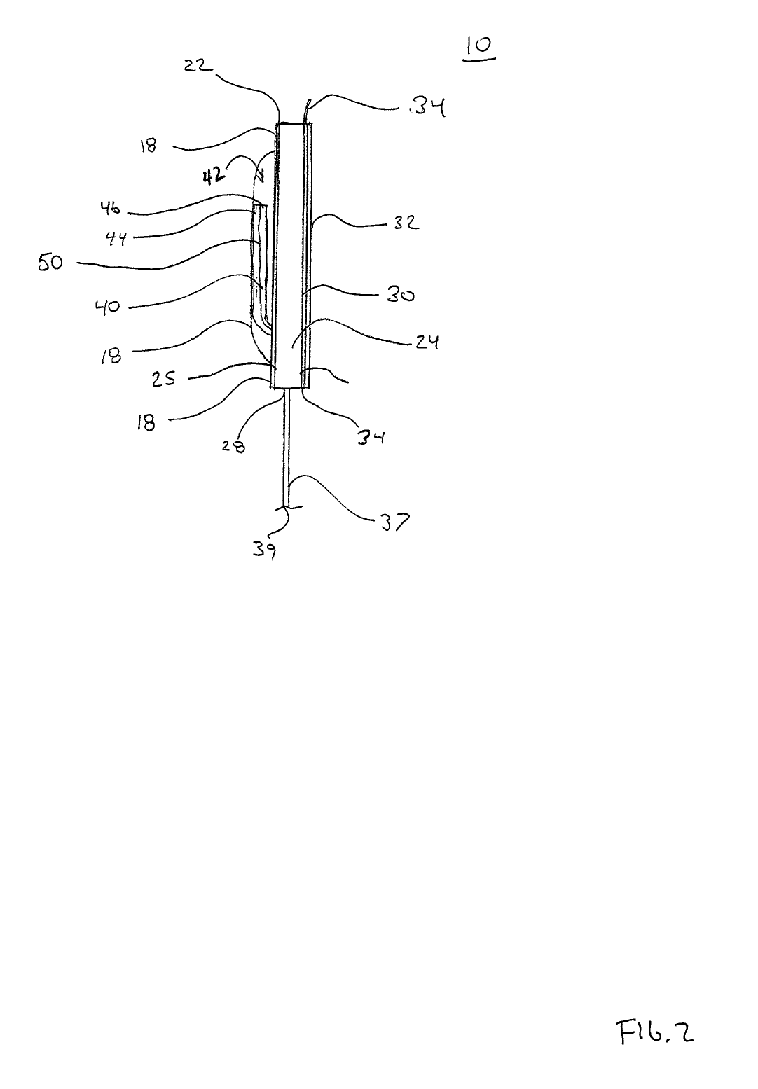

As shown in FIGS. 1 and 2, one embodiment the earpiece 10 for auditory testing may comprise a cover 18 and a first baffle 24 having a first side 25 and a second side 26. The cover may be attached to the first side 25 of the first baffle 24, thereby creating a cavity or chamber 27. Further, a hole 28 may be disposed through baffle 24 so that a tube 37 or other sound delivering device, may be inserted through the hole 28. Also, earpiece 10 may include a second baffle 40 which defines a cavity or chamber 42.

The first baffle 24 may be constructed so that the baffle 24 can fit completely around a patient's ear and be removably attached to the patient's head. The baffle 24 may be substantially oval shaped, circular shaped, square shaped or any shape that will fit around a patient's ear and removably attach to the patient's head. Further, shape and size of the first baffle 24 may be dictated by the particular application for which the earpiece 10 is to be used. The baffle 24 may have a thickness in the range 0.25 to 1.00 inches, a minor diameter in the range 1.50 to 4.00 inches and a major diameter in the range 2.00 to 4.50 inches. In yet other embodiments, the baffle 24 may have any size dimensions required to fit a particular sized or shaped patient's ear. The baffle 24 may be constructed of a foam rubber, elastomer or any other material that is flexible and/or pliable and can provide for an acoustical impedance that is higher than that of air. For some applications, it may be desirable to construct the baffle 24 from a rigid material such as a plastic or metal.

In one embodiment, a cover 18 may be attached to the first side 25 of baffle 24. In some embodiments, the cover 18 may be planar, or, in other embodiments the cover 18 may be non-planar. In a preferred embodiment, the cover 18 may be substantially concave in shape as shown in FIG. 2. Further, in other embodiments, the cover 18 may be any other shape that will provide for proper operation of the earpiece 10. Depending on the application, the cover 18 may be transparent, translucent or opaque. If it is necessary or desirable to view the patient's ear when positioning the earpiece 10 around the patient's ear, the cover 18 or a significant portion thereof may be substantially transparent or translucent. The cover 18 may be fixed to the first side 25 of baffle 24 by an adhesive 20 or by any other means that will provide for proper operation of earpiece 10. In one embodiment, the cover 18 may be shaped and configured so that when the earpiece 10 is attached to the side of a patient's head, the patient's ear does not come into contact with any portion of the earpiece 10, including the baffle 24 and the cover 18. In yet other embodiments, the cover 18 may be configured so that when the earpiece 10 is attached to the side of a patient's head, the patient's ear may come into contact with one or more portions of the earpiece 10.

The earpiece 10 may also comprise a second baffle 40 as shown in FIG. 1. A second baffle 40 may be constructed of a foam rubber, elastomer or any other material that is flexible and/or pliable and can provide for an acoustical impedance that is higher than that of air. For some applications, it may be desirable to construct the baffle 40 from a rigid material such as a plastic or metal. The baffle 40 may be shaped substantially as shown in FIGS. 1 and 2 to form a second cavity 42. As shown in FIG. 1, the illustrated baffle 40 may have a first end 47 and a second end 48. The first end 47 is formed by tapering a portion of baffle 40 as shown. The second end 48, as illustrated, may be substantially circular in shape. In yet other embodiments, the baffle 40 may have a second end 48 that is, for example, square shaped, triangular, octagonal shape or any other shape that will provide for proper operation of earpiece 10.

As shown in FIG. 2, the baffle 40 may be constructed of two portions which includes a first portion 44 and a second portion 46. The first portion 44 may be fixed to the second portion 46 by an adhesive 50 or by any other means that will provide proper operation of the earpiece 10. In other embodiments, the second baffle 40 may constructed of a single piece of material. Tube 37, or other sound deliver device (e.g., a sound transducer), may be positioned in hole 43 substantially as shown in FIG. 1. Tube 37 may have a first end 38 and a second end 39. In a preferred embodiment, the tube 37 is constructed of 2.5 inch in length silicone rubber tube with a 0.05 inch inner diameter. In alternate embodiments, the tube 37 may be constructed of any material that will provide for proper operation of earpiece 10. In one embodiment, tube 37 is capable of delivering auditory tones or sounds to earpiece 10. In one embodiment, the tube 37 may be flexible and constructed of a soft, bendable material such as rubber, plastic, etc. In yet other embodiments, the tube 37 may be constructed of a rigid, non-bendable material such as, for example, plastic, steel, etc. In yet other embodiments, any type of sound delivering device may be substituted for tube 37, for example, a miniature electronic transducer.

As shown in FIG. 1, the second baffle 40 may be positioned within the cavity 27 of the first baffle 24 so that the first end 47 of the second is proximate the first baffle 24. The second baffle 40 may have a hole or an aperture 43 which is large enough to accept tube 37. In a preferred embodiment, hole 43 is located in the first end 47 of baffle 40. In another embodiment, tube 37 may be positioned between second baffle first portion 44 and second portion 46 at the first end 47 so that tube 37 may communicate with the second cavity 42. When positioned in first end 47, first end 38 of tube 37 may extend past the first end 47 of the second baffle 40 and into second baffle cavity 42. In an alternate embodiment, first end 38 may not extend past the first end 47 into second baffle cavity 42. In yet still other embodiments, first end 38 of tube 37 may be adjusted to extend past first end 47 and into second cavity 42 for any distance that may be required for the specific application. The tube 37 may be held in place in the first baffle 24 and the second baffle 40 by an adhesive, or the tube 37 may be held in place by frictional forces exerted on the tube 37 by the first and second baffles 24, 40.

As shown in FIG. 1, second baffle 40 may be positioned within cavity 27 so that first end 47 is bent on an angle to allow second end 48 to be positioned proximate and substantially parallel to the convex-shaped cover 18. The second end 48 may be attached to the cover 18 with an adhesive or any other means that will provide for proper operation of earpiece 10. In yet other embodiments, no portion of second baffle 40 may be fixed to cover 18 while in other embodiments the second baffle 40 may be integral with the cover 18. In still other embodiments, second baffle 40 may contain bendable wire or other firm bendable material that runs through the length of second baffle 40. The wire (not shown) provides for the baffle 40 to be bent into the desired shape necessary for the testing procedure. As depicted in FIG. 1, the second baffle 40 may be manipulated to achieve the desired shape and may be retained in that shape without requiring adhesive to hold the baffle 40 in position proximate cover 18. In yet other embodiments, the second baffle 40 may be manufactured to provide the baffle 40 with the desired shape to realize a configuration (or other configuration) as shown in FIG. 1.

The second side 26 of the first baffle 24 may have a conductive layer or transducer 34 coupled to it as shown in FIG. 1. The conductive layer 34 may extend along the entire side portion 26 or may only cover a portion of the surface area of side 26. Conductive layer 34 may have a tab 35 that extends past baffle 24. Tab 35 may be configured to provide for an electrode, wire or other device to be attached to it, for example by using a clamp or alligator clip. As shown in FIG. 1, the conductive layer 34 covers only a portion of second side 26. Conductive layer 34 may be constructed of silver/silver-chloride carbon film (mixture of silver/silver-chloride on a carbon film), silver oxide or any other material that will act as a conductor and provide for proper operation of earpiece 10. In one embodiment, conductive layer 34 may be attached to side 26 with an adhesive 30.

A coating 32 may be applied over conductive layer 34. As shown in FIG. 2, in one embodiment, coating 32 may be applied to bottom 26 so that the entire area of side 26 is covered with coating 32. In yet other embodiments, coating 32 may only cover a portion of side 26 and layer 34. Coating 32 may be, for example, one of the known electrically conductive gels having adhesive characteristics.

In use, earpiece 10 is positioned on the side of a patient's head by aligning the first cavity 27 with the patient's ear and aligning the second cavity 42 over the patient's ear canal. In one embodiment, the earpiece 10 is then pressed on the patient's head while the patient's ear is viewed through the substantially transparent cover 18 to ensure that the second cavity 42 is properly aligned with the patient's ear canal. Acting as an adhesive, coating 32 may keep earpiece 10 in its preferred position which is on the side of the patient's head. Coating 32 may also provide for an acoustical seal between the patient's skin and the earpiece 10. Once the baffles 24, 40 are properly aligned, an auditory tone or sound is introduced into the first end 38 of tube 37. Tone travels through the tube 37 into cavity 42. The second baffle 40 and cavity 42 direct the sound into the patient's ear canal. Since the second baffle 40 and cavity 42 are smaller than the first baffle 24 and cavity 27, the second baffle 40 minimizes the bouncing or reflection of sound waves off the baffle 40 and cover 18 within cavity 42. The second baffle 40 directs the sound waves into the ear canal. Furthermore, the amount of sound that escapes through or bounces off of cover 18 is minimized because the surface area of cover 18 is minimized by baffle 40. The cover 18, baffle 24 and baffle 40 further block external ambient noise from entering cavity 42 thereby leaving the cavity 42 substantially free of external sounds during hearing testing. As a result, external noises do not interfere with the introduced tones, and patient's response can be more accurately tested.

After the sound enters the ear canal, a response from the patient occurs as a result of the characteristics of the introduced sound, the conditions inside the ear, the vibration transmission mechanism of the ear and the neural connections of the ear. In one embodiment, part of the response may be conveyed by coating 32 and layer 34. A response may also be conveyed through the tube 39 to analyzing equipment (not shown). Layer 34 may be connected by an electrode, lead and/or wire to equipment that can analyze and process the patient's response to the introduced tone. The patient's response can also be displayed on a monitor or other viewing apparatus for further analysis. After the testing is complete, the earpiece 10 may be easily removed from the patient's skin by pulling the earpiece 10 away from the patient's head. Tube 37 may be easily removed from earpiece 10 and may be reused. Earpiece 10 may be discarded.

Specific embodiments of novel methods and apparatus for construction of novelty earpieces for auditory testing according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An earpiece for auditory testing, comprising:
a first baffle;
a cover attached to the first baffle forming a first cavity; and
a second baffle positioned within the first cavity,
wherein least a portion of the second baffle is attached to one of the cover and the first baffle to form a second cavity.

2. The earpiece of claim 1, wherein the second baffle is adapted to be coupled to a sound source to permit sound to be directed into the second cavity.

3. The earpiece of claim 1, wherein the first baffle is sized large enough to fit around an ear.

4. The earpiece of claim 1, wherein the first baffle has a first side and a second side and wherein an adhesive attaches the first side to the cover.

5. The earpiece of claim 1, wherein the cover is non-planar.

6. The earpiece of claim 1, wherein the cover is planar.

7. The earpiece of claim 1, wherein at least a portion of the cover is substantially transparent.

8. The earpiece of claim 1, further comprising a conductive element coupled to the first baffle.

9. The earpiece of claim 8, wherein the conductive element is made of a silver/silver-chloride carbon film.

10. The earpiece of claim 8, wherein the conductive element further comprises a tab portion that extends past the first baffle.

11. The earpiece of claim 1, further comprising a conductive adhesive coating covering at least a portion of the first baffle.

12. The earpiece of claim 1, wherein the second baffle is comprised of a first portion and a second portion and where the first portion is attached to the second portion to form an integral second baffle.

13. The earpiece of claim 1, further comprising a tube for connecting a sound source to the second cavity.

14. The earpiece of claim 1, wherein the second baffle further comprises an aperture for coupling a sound source to the second cavity.

15. The earpiece of claim 1, wherein the cover further comprises an aperture for coupling a sound source to the second cavity.

16. The earpiece of claim 1, further comprising a transducer which delivers sound into the second cavity.

17. The earpiece of claim 1, wherein the first baffle is constructed of flexible foam material.

18. The earpiece of claim 1, wherein the second baffle is constructed of flexible foam material.

19. An earpiece for auditory testing, comprising:
means for forming an acoustic boundary capable of encircling an ear;
means for covering the forming means to create a first chamber; and
means located within the first chamber for creating a second chamber.

20. The earpiece of claim 19, further comprising means for delivering sound into the second chamber.

21. The earpiece of claim 20, wherein the means for delivering sound is a tube that communicates with the second chamber.

22. The earpiece of claim 19, wherein at least a portion of the means for covering is substantially transparent.

23. A method for auditory testing, comprising the steps of:
forming a first chamber over an ear;
forming a second chamber located within the first chamber;
aligning the second chamber so that the second chamber is operatively positioned over an ear canal; and
introducing sound into the second chamber.
